(19) United States
(12) Patent Application Publication
(10) Pub. No.: US 2016/0324722 A1
(43) Pub. Date: Nov. 10, 2016

(54) METHOD, SYSTEM AND INFLATABLE DEVICE FOR ADMINISTRATION OF NEGATIVE PRESSURE VENTILATION IN RESPIRATORY FAILURE

(71) Applicant: ST. MICHAEL'S HOSPITAL, Toronto (CA)

(72) Inventors: Christer SINDERBY, Toronto (CA); Jennifer BECK, Toronto (CA); Norman COMTOIS, Scarborough (CA)

(73) Assignee: ST. MICHAEL'S HOSPITAL, Toronto, ON (CA)

(21) Appl. No.: 15/108,146

(22) PCT Filed: Dec. 23, 2014
(86) PCT No.: PCT/CA2014/051258

§ 371 Date: Jun. 24, 2016

Related U.S. Application Data
(60) Provisional application No. 61/921,721, filed on Dec. 30, 2013.

(51) Int. Cl. A61H 31/02; A61H 9/00

(52) U.S. Cl. CPC A61H 31/02; A61H 9/0078; A61H 9/0057; A61H 2230/605; A61H 2201/1616; A61H 2201/163

(57) ABSTRACT

A negative pressure ventilation device comprises an inflatable tubular enclosure for surrounding a patient's torso and for defining, when inflated, a space between the tubular enclosure and the patient's torso. A sealing arrangement for the space between the tubular enclosure and the patient's torso is configured for positioning between the tubular enclosure and the patient's torso. A port is mounted to the inflatable tubular enclosure for accessing the space between the enclosure and the patient's torso to produce a negative pressure in the space. A method for negative pressure ventilation using the foregoing negative pressure ventilation device and a negative pressure ventilation system comprising the negative pressure ventilation device are also disclosed.

### TECHNICAL FIELD

The present disclosure relates to the field of ventilatory assist. More specifically, the present disclosure relates to an inflatable device for administering negative pressure ventilation to a patient, to a negative pressure ventilation method using this inflatable device, and to a ventilatory assist system including this inflatable device.

### BACKGROUND

Nowadays, respiratory life support is commonly administered to a patient by applying positive air pressure, flow, and/or volume into the patient's airways and lungs via the oro-nasal cavities, via tracheal intubation (through airways or tracheostomy), etc. However, respiratory life support can also be administered by applying negative pressure around the patient's chest wall (so-called negative pressure ventilation) using for example a shell (a so-called cuirass) covering the thorax or a tank accommodating the entire body of the patient except for the head (a so-called iron lung).

Problems of bulkiness causing requirements for large storage space as well as problems of fitting these negative pressure devices to various body configurations have limited the popularity of such cuirasses and iron lungs. Synchronizing respiratory assist delivery to patient's breathing effort in non-apneic patients also is a problem with negative pressure ventilation.

Therefore, there is a need for improvements to current devices for administering negative pressure ventilation, to provide a negative pressure ventilation device that is lightweight, easy to fit to different body configurations, and that requires minimal storage space.

### SUMMARY

According to the present disclosure, there is provided a negative pressure ventilation device. The device includes an inflatable tubular enclosure for surrounding a patient's torso and for defining, when inflated, a space between the tubular enclosure and the patient's torso. A sealing arrangement of the space between the tubular enclosure and the patient's torso is provided for positioning between the tubular enclosure and the patient's torso. An access port is mounted to the inflatable tubular enclosure for producing a negative pressure in the space between the tubular enclosure and the patient's torso.

According to the present disclosure, there is also provided a method for negative pressure ventilation. The method uses the aforementioned negative pressure ventilation device by inflating the tubular enclosure surrounding a patient's torso for defining a space between the tubular enclosure and the patient's torso and by producing through the port mounted to the inflatable tubular enclosure a negative pressure in the space between the enclosure and the patient's torso.

The present disclosure further relates to a negative pressure ventilation system. The system comprises the aforementioned negative pressure ventilation device, a neural controller configured to receive a signal representative of an inspiratory effort of the patient and to produce a synchronization control signal in response to the received inspiratory effort representative signal, and a pressure controller for producing a negative pressure in the space between the tubular enclosure and the patient's torso in response to the synchronization control signal from the neural controller.

The foregoing and other features will become more apparent upon reading of the following non-restrictive description of illustrative embodiments, given by way of example only with reference to the accompanying drawings.

### BRIEF DESCRIPTION OF THE DRAWINGS

Embodiments of the disclosure will be described by way of example only with reference to the accompanying drawings, in which:

FIG. 1 is a top plan view of a negative pressure ventilation device according to one embodiment;

FIG. 2 is a cross sectional view of the negative pressure ventilation device of FIG. 1;

FIG. 3 is a top plan view of a negative pressure ventilation device according to another embodiment; and

FIG. 4 is block diagram of a negative pressure ventilation system including the device of FIG. 1 or 3.

### DETAILED DESCRIPTION

The present disclosure generally addresses negative pressure ventilation of a patient by application of a negative pressure around the patient's torso.

More specifically, the present disclosure describes a negative pressure ventilation device and a corresponding method for administering negative pressure ventilation to a patient by applying a negative pressure around the patient's torso, including the patient's thorax and abdomen, expanding the same and consequently expanding the patient's lungs. This negative pressure ventilation device presents the advantages of being lightweight, and easy to fit to various body configurations. The negative pressure ventilation device is also self-sustained, requires minimal storage space, and is well suited as a disposable device.

The following terminology is used throughout the present disclosure:
Air: Any gas composition suitable for use in a ventilatory assist system. In the context of the present disclosure, the term “air” may refer to natural air, pure oxygen, natural air enriched with added oxygen, oxygen mixed with another gases such as water vapor, or any combination thereof. This term may also refer to air expelled from a patient's lungs, for example natural air containing additional CO₂ and humidity.
Inspiratory effort: Voluntary or involuntary exertion of a breathing patient. This may be quantified as a neural measure.
Synchrony: Time-wise correspondence or proportionality between events.

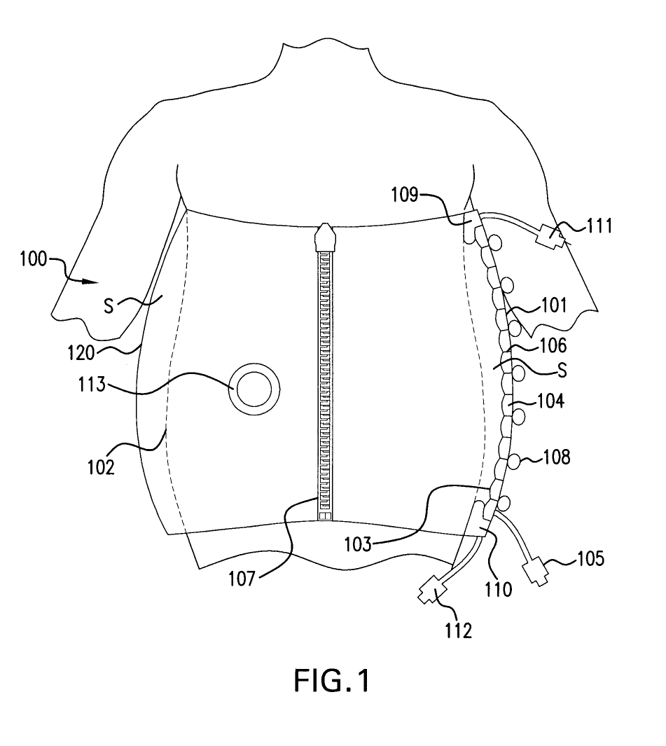

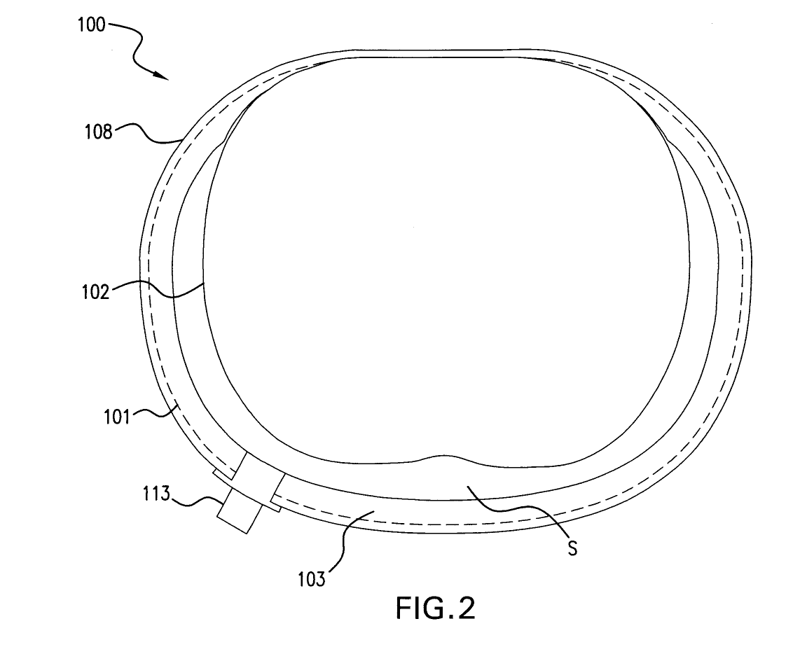

Referring to FIGS. 1 and 2, the negative pressure ventilation device 100 defines an inflatable tubular enclosure 120 for surrounding the patient's torso 102, including the thorax and abdomen. When inflated, the tubular enclosure 120 is an outwardly bulging enclosure as illustrated in FIG. 1.

The tubular enclosure 120 of the inflatable negative pressure ventilation device 100 comprises a membrane 101 made of flexible, non-elastic or semi-elastic material. Advantageously, the material forming the membrane 101 will be air-tight to enable building-up of a negative pressure inside the negative pressure ventilation device 100. Suitable material for the membrane 101 may comprise, as non-limitative examples, Mylar™, neoprene, gore-tex, and the like.

The tubular enclosure 120 of the inflatable negative pressure ventilation device 100 includes, on the inner side of the membrane 101, a system 103 of transversally oriented inflatable tubular bladders such as 104 surrounding the patient's torso 102. As illustrated in FIGS. 1 and 2, the system 103 of inflatable bladders 104 may encircle the entire patient's torso 102 at all levels of the torso. More specifically, the system 103 may be formed of laterally adjacent, transversally oriented inflatable tubular bladders 104 each forming a loop around the patient's torso 102. For example:
the inflatable tubular bladders 104 can be made of flexible, non-elastic or semi-elastic plastic material;
the inflatable tubular bladders 104 can be mounted to the inner side of the membrane 101 through, for example, an adhesive; and
each pair of laterally adjacent inflatable bladders 104 may comprise a common wall such as 106 interconnecting the two bladders together, whereby the membrane 101 and the system 103 of inflatable bladders 104 form an air-tight tubular enclosure 120 allowing building up of a negative pressure between the tubular enclosure 120 and the patient's torso 102.

In operation, the system 103 of bladders 104 can be inflated using gas or liquid to form the outwardly bulging, tubular shape of the negative pressure ventilation device 100. More specifically, when being inflated, the system 103 of bladders 104 expands in all directions, especially longitudinally, to stabilize the tubular enclosure 120 of the negative pressure ventilation device 100 in its outwardly bulging tubular shape. The inflatable, negative pressure ventilation device 100, when the bladders 104 are inflated, forms a substantially non-collapsible, stable structure defining between the system 103 of inflatable bladders 104 and the patient's torso 102 a space S required to apply negative pressure and allow the patient's torso 102, including the thorax and abdomen, to expand and in turn expanding the patient's lungs in response to such negative pressure.

Advantageously, the inflatable bladders 104 can be interconnected to enable simultaneous inflation of all bladders 104 by a pressure source (not shown) via an access port 105. In this manner, either gas or liquid may enter and exit the system 103 to pressurize and de-pressurize the bladders 104 simultaneously via the same port 105. For example, holes in the common walls 106 may be provided to interconnect the bladders 104. Alternatively, conduit means in fluid communication with the port 105 may be provided in the system 103 to supply or withdraw gas or liquid to or from the bladders 104 simultaneously through the same access port 105.

The system 103 can be structured to allow gas or liquid to both enter and exit the inflatable bladders 104 through different inlet and outlet ports while controlling the resistance of flow of the gas or liquid to thereby maintain a certain, predetermined pressure in the inflatable bladders 104. This design will allow circulation of gas or liquid through the inflatable bladders 104 while maintaining a positive pressure therein ensuring structural stability of the system 103 of inflatable bladders 104. In such a design, the gas or liquid may be tempered via a heating or cooling system to increase or decrease the temperature around the patient's torso 102.

With continuing reference to FIGS. 1 and 2, the tubular enclosure 120 of the negative pressure ventilation device 100 may be provided with at least one sealed closure system, for example a zipper 107 (FIG. 1) or a Velcro™ fastening (not shown), allowing the tubular enclosure 120 to be opened and closed upon placement on and removal from the patient, respectively. More specifically, the sealed closure system will allow the tubular enclosure 120 of the negative pressure ventilation device 100 to be easily opened, applied around the patient's torso 102 and then closed or opened and then removed from the patient's torso 102.

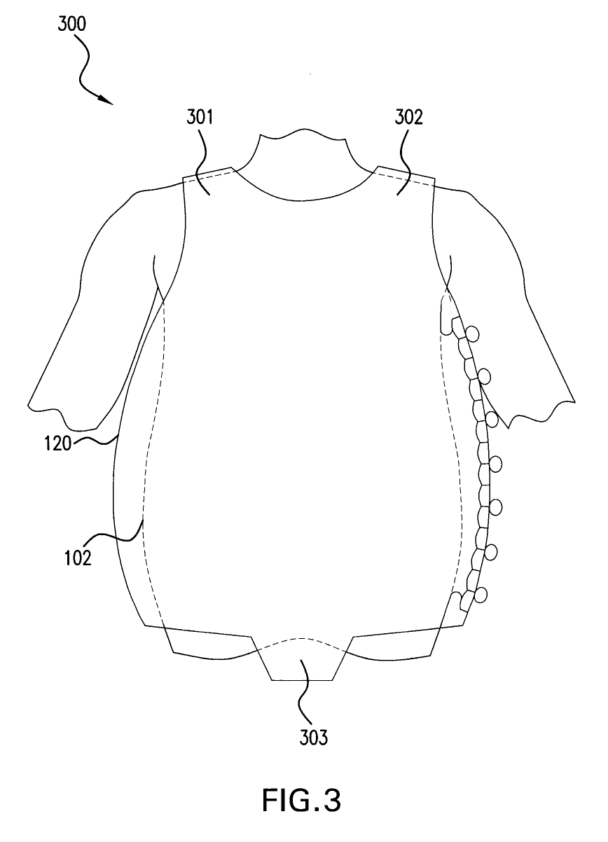

Referring to FIG. 3, in a variant, the tubular enclosure 120 of a negative pressure ventilation device 300 is provided with shoulder flaps 301, 302 that can be divided and re-attached using, for example, Velcro™ fastening. In this manner, the shoulder flaps 301, 302 can be applied over the patient's shoulders without the need to bypass the patient's arms through the vest formed by the inflatable negative pressure ventilation device 100. In the same manner, the tubular enclosure 120 may be provided with groin flaps 303 that can be divided and re-attached through, for example, Velcro™ fastening, allowing such flaps 303 to be applied between the patient's legs e.g. to secure diapers.

Referring back to FIGS. 1 and 2, the tubular enclosure 120 of the negative pressure ventilation device 100 may comprise rigid or flexible annular members 108 attached to the membrane 101, for example to the outer side of the membrane 101 by means of an adhesive or Velcro™ fastening, to form a non-inflatable exoskeleton structure that supports the outwardly bulging, tubular shape of the inflatable tubular enclosure 120 of the negative pressure ventilation device 100. Specifically, the annular members 108 of the exoskeleton structure form trusses to stabilize the cross-sectional shape of the inflatable tubular enclosure 120. The annular members 108 of the exoskeleton structure may encircle part of or the entire torso at all levels of the patient's torso 102. Of course, the annular members 108 have a diameter matching those of the membrane 101 and inflatable bladders 104 located at the same level. When a sealed closure system such as the zipper 107 of FIG. 1 is provided, the annular members 108 of the exoskeleton structure may comprise articulated joints, if required by the level of stiffness or rigidity of the annular members 108, to allow opening up the negative pressure ventilation device 100 for placement thereof onto or removal thereof from the patient's torso 102. Inflation of the bladders 104 causes the tubular enclosure 120 to stretch out lengthwise while spreading the annular members 108 apart from each other. When annular members 108 are provided, it is therefore possible to control the length of the tubular enclosure 120 by controlling the level of pressure in the inflatable bladders 104. In other words, the pressure in the bladders 104 will determine the length of the negative pressure ventilation device 100. In a similar manner, deflation of the bladders 104 will cause the tubular enclosure 120 to collapse and shrink lengthwise with the annular members 108 coming closer to each other; bulkiness of the device 100 is reduced and less storage space is required.

In order to further increase stability and prevent collapse when negative pressure is applied between the inflatable tubular enclosure 120 of the negative pressure ventilation device 100 and the patient's torso 102, additional flexible structures (not shown) acting as trusses can be mounted on the tubular enclosure 120 in the longitudinal direction of the patient's torso. For example, these trusses can be mounted via e.g. Velcro™ material to the outer side of the membrane 101.

The negative pressure ventilation device 100 may further comprise an apical annular seal 109 between the tubular enclosure 120 and the patient's torso 102 and a caudal annular seal 110 between the tubular enclosure 120 and the patient's torso 102 to prevent gaseous leaks when negative pressure is applied in the space S between the inflatable tubular enclosure 120 and the patient's torso 102. The apical 109 and caudal 110 seals are tubular and inflatable. They can be mounted to the inner side of the membrane 101 through, for example, an adhesive. The apical 109 and caudal 110 seals can be made of stretchable materials such as rubber, polyurethane or other polymer, etc., surrounding the upper thorax and pelvis, respectively, at the interior of the device 100. The tubular enclosure 120 of the negative pressure ventilation device 100 will be sealed at the level of, for example, the upper ribcage and at the level of, for example, the pelvic area by inflating the apical 109 and caudal 110 seals; inflation of the apical 109 and caudal 110 seals with gas or liquid through the ports 111 and 112, respectively, will seal and, therefore, hermetically close the space S between the patient's torso and the tubular enclosure 120. The inflated apical 109 and caudal 110 seals will be sucked into the space S between the system 103 of inflatable bladders 104 and the patient's torso 102 to improve sealing as the negative pressure increases in this space S thus preventing air to leak inside the tubular enclosure 120 of the device 100.

The inflatable negative pressure ventilation device 100 is provided with at least one access port/connector 113 that penetrates though the inflatable tubular enclosure 120 of the device 100 for the purpose of applying negative pressure, for example negative air pressure inside the tubular enclosure 120 of the device 100 when positioned on the patient's torso 102 and inflated. This access port/connector 113 connects to a negative pressure generating device used to adjust pressure in the space S between the tubular enclosure 120 and the patient's torso 113.

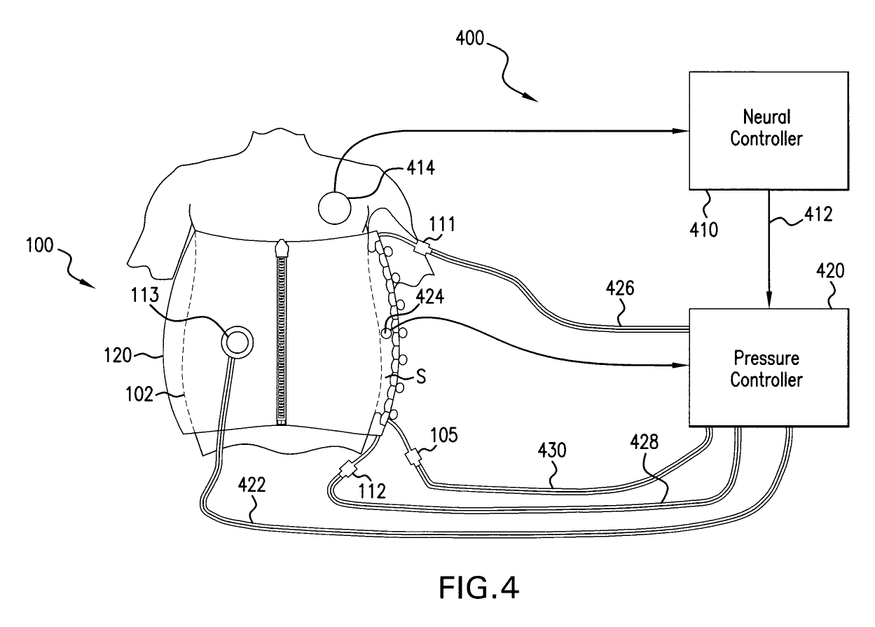

FIG. 4 is a block diagram of a negative pressure ventilation system 400 including the device of FIG. 1 or 3. In the negative pressure ventilation system 400, the device 100 (or alternatively the device 300) is connected to a neural controller 410. A sensor 414, only schematically illustrated in FIG. 4, produces a signal representative of an inspiratory effort of the patient, for example an electromyographic (EMG) signal from a patient's respiratory muscle. In response to the inspiratory effort representative signal from the sensor 414, the neural controller 410 produces a synchronization control signal 412 supplied to a pressure controller 420. A pressure sensor 424 may also be provided to measure the negative pressure in the space S and supply a negative pressure measurement to the pressure controller 420. In response to the synchronization control signal 412 and the negative pressure measurement in the space S, the pressure controller 420 delivers a negative pressure to the space S between the inflatable tubular enclosure 120 and the patient's torso 102 via a conduit 422 and the access port/connector 113. The negative pressure is delivered to the space S between the inflatable tubular enclosure 120 and the patient's torso 102 in synchrony and with inverse magnitude to the inspiratory effort representative signal from the sensor 414. Specifically, the negative pressure applied between the tubular enclosure 120 and the patient's torso 102 will become more negative (lower) as the patient's neural inspiratory effort increases. U.S. Pat. No. 7,909,034 B2 granted to Sinderby et al., entitled “COMBINED POSITIVE AND NEGATIVE PRESSURE ASSIST VENTILATION” of which the full content is herein incorporated by reference, provides examples of sensors, neural controllers and pressure controllers that can be used for this purpose.

It is possible to adjust the respective positive pressures in the apical 109 and caudal 110 seals in synchrony with the breathing cycles to minimize the respective pressures applied by these seals 109 and 110 to the skin surface at the seal areas. For this purpose, the pressure controller 420 is connected to the apical 109 and caudal 110 seals via respective conduits 426 and 428 and through respective ports 111 and 112 and adjusts their respective inner positive pressures for example as a function of the pressure measured in the space S through the sensor 424 and/or as a function of the synchronization control signal 412.

The pressure controller 420 can also be used to inflate the bladders 104 by supplying a gas pressure via a conduit 430 to a port 105. A separate pressure controller (not shown) may be used when the bladders are inflated by liquid injection. It may be observed that inflation of the bladders 104 is not related to the respiratory cycle.

The following is an additional description showing possible combinations of the present disclosure:

A negative pressure ventilation device, comprising: an inflatable tubular enclosure for surrounding a patient's torso and for defining, when inflated, a space between the tubular enclosure and the patient's torso; a sealing arrangement for the space between the tubular enclosure and the patient's torso, the sealing arrangement being positioned between the tubular enclosure and the patient's torso; and a port mounted to the inflatable tubular enclosure for accessing the space between the enclosure and the patient's torso to produce a negative pressure in the space.

A negative pressure ventilation device, comprising: an inflatable tubular enclosure for surrounding a patient's torso and for defining, when inflated, a space between the tubular enclosure and the patient's torso; a sealing arrangement for the space between the tubular enclosure and the patient's torso, the sealing arrangement being positioned between the tubular enclosure and the patient's torso; and a port mounted to the inflatable tubular enclosure for accessing the space between the enclosure and the patient's torso to produce a negative pressure in the space. The tubular enclosure comprises a membrane and a system of inflatable bladders on an inner side of the membrane, wherein the inflatable bladders are transversally oriented tubular bladders.

A negative pressure ventilation device, comprising: an inflatable tubular enclosure for surrounding a patient's torso and for defining, when inflated, a space between the tubular enclosure and the patient's torso; a sealing arrangement for the space between the tubular enclosure and the patient's torso, the sealing arrangement being positioned between the tubular enclosure and the patient's torso; and a port mounted to the inflatable tubular enclosure for accessing the space between the enclosure and the patient's torso to produce a negative pressure in the space. The tubular enclosure comprises a system of inflatable bladders including inlet and outlet ports to allow gas or liquid to enter and exit the inflatable bladders while maintaining a certain pressure in the bladders.

A negative pressure ventilation device, comprising: an inflatable tubular enclosure for surrounding a patient's torso and for defining, when inflated, a space between the tubular enclosure and the patient's torso; a sealing arrangement for the space between the tubular enclosure and the patient's torso, the sealing arrangement being positioned between the tubular enclosure and the patient's torso; and a port mounted to the inflatable tubular enclosure for accessing the space between the enclosure and the patient's torso to produce a negative pressure in the space. The negative pressure ventilation device comprises at least one sealed closure system to open and close the tubular enclosure.

A negative pressure ventilation device, comprising: an inflatable tubular enclosure for surrounding a patient's torso and for defining, when inflated, a space between the tubular enclosure and the patient's torso; a sealing arrangement for the space between the tubular enclosure and the patient's torso, the sealing arrangement being positioned between the tubular enclosure and the patient's torso; and a port mounted to the inflatable tubular enclosure for accessing the space between the enclosure and the patient's torso to produce a negative pressure in the space. The tubular enclosure further comprises an exoskeleton structure.

A negative pressure ventilation device, comprising: an inflatable tubular enclosure for surrounding a patient's torso and for defining, when inflated, a space between the tubular enclosure and the patient's torso; a sealing arrangement for the space between the tubular enclosure and the patient's torso, the sealing arrangement being positioned between the tubular enclosure and the patient's torso; and a port mounted to the inflatable tubular enclosure for accessing the space between the enclosure and the patient's torso to produce a negative pressure in the space. The sealing arrangement comprises apical and caudal annular seals between the tubular enclosure and the patient's torso, wherein the apical and caudal annular seals are tubular and inflatable.

A method for negative pressure ventilation using the above described negative pressure ventilation device, comprises inflating the tubular enclosure surrounding a patient's torso for defining a space between the tubular enclosure and the patient's torso, and producing through the port mounted to the inflatable tubular enclosure a negative pressure in the space between the enclosure and the patient's torso.

A method for negative pressure ventilation using the above described negative pressure ventilation device, comprises inflating the tubular enclosure surrounding a patient's torso for defining a space between the tubular enclosure and the patient's torso, and producing through the port mounted to the inflatable tubular enclosure a negative pressure in the space between the enclosure and the patient's torso. Inflating the tubular enclosure comprises inflating the system of inflatable bladders.

A method for negative pressure ventilation using the above described negative pressure ventilation device, comprises inflating the tubular enclosure surrounding a patient's torso for defining a space between the tubular enclosure and the patient's torso, and producing through the port mounted to the inflatable tubular enclosure a negative pressure in the space between the enclosure and the patient's torso. The method comprises circulating gas or liquid through the system of inflatable bladders through inlet and outlet ports while maintaining a certain pressure in these bladders.

A method for negative pressure ventilation using the above described negative pressure ventilation device, comprises inflating the tubular enclosure surrounding a patient's torso for defining a space between the tubular enclosure and the patient's torso, and producing through the port mounted to the inflatable tubular enclosure a negative pressure in the space between the enclosure and the patient's torso. The method comprises (a) circulating gas or liquid through the system of inflatable bladders through inlet and outlet ports while maintaining a certain pressure in these bladders, and (b) tempering the gas or liquid.

A method for negative pressure ventilation using the above described negative pressure ventilation device, comprises inflating the tubular enclosure surrounding a patient's torso for defining a space between the tubular enclosure and the patient's torso, and producing through the port mounted to the inflatable tubular enclosure a negative pressure in the space between the enclosure and the patient's torso. The sealing arrangement comprises apical and caudal annular seals for positioning between the tubular enclosure and the patient's torso, the apical and caudal annular seals are tubular and inflatable, and the method comprises inflating the apical and caudal annular seals and adjusting a pressure in these apical and caudal annular seals in synchrony with patient's breathing cycles.

Those of ordinary skill in the art will realize that the description of the inflatable negative pressure ventilation device, the negative pressure ventilation system and the method for negative pressure ventilation using the negative pressure ventilation device is illustrative only and is not intended to be in any way limiting. Other embodiments will readily suggest themselves to such persons with ordinary skill in the art having the benefit of the present disclosure. Furthermore, the disclosed device may be customized to offer valuable solutions to existing needs and problems related to ventilatory assist to patients.

Although the present disclosure has been described hereinabove by way of non-restrictive, illustrative embodiments thereof, these embodiments may be modified at will within the scope of the appended claims without departing from the spirit and nature of the present disclosure.

1. A negative pressure ventilation device, comprising:
an inflatable tubular enclosure for surrounding a patient's torso, the inflatable tubular enclosure comprising a system of inflatable bladders disposed laterally adjacent to each other to define, when inflated, a space between the tubular enclosure and the patient's torso;
a sealing arrangement for the space between the tubular enclosure and the patient's torso, said sealing arrangement for positioning between the tubular enclosure and the patient's torso; and
an access port mounted to the inflatable tubular enclosure for producing a negative pressure in the space between the tubular enclosure and the patient's torso.

2. The negative pressure ventilation device of claim 1, wherein the tubular enclosure forms, when inflated, an outwardly bulging tubular enclosure.

3. The negative pressure ventilation device of claim 1, comprising at least one sealed closure system to open and close the tubular enclosure.

4. The negative pressure ventilation device of claim 1, wherein the tubular enclosure comprises shoulder and groin flaps that can be divided and re-attached upon placement and withdrawal of the negative pressure ventilation device on and from the patient's torso.

5. The negative pressure ventilation device of claim 1, wherein the tubular enclosure further comprises an exoskeleton structure.

6. The negative pressure ventilation device of claim 5, wherein the exoskeleton structure comprises annular members encircling the patient's torso.

7. The negative pressure ventilation device of claim 6, wherein the annular members form trusses to stabilize a cross-sectional shape of the tubular enclosure.

8. The negative pressure ventilation device of claim 1, further comprising longitudinal trusses mounted on the tubular enclosure.

9. The negative pressure ventilation device of claim 1, wherein the port is a port/connector.

10. The negative pressure ventilation device of claim 1, wherein the tubular enclosure further comprises a membrane, wherein the system of inflatable bladders is on an inner side of the membrane.

11. The negative pressure ventilation device of claim 1, wherein the inflatable bladders are transversally oriented tubular bladders surrounding the patient's torso.

12. The negative pressure ventilation device of claim 1, wherein the system of inflatable bladders comprises laterally adjacent bladders, and wherein each pair of laterally adjacent bladders comprises a common wall.

13. The negative pressure ventilation device of claim 12, wherein the common wall comprises holes therein.

14. The negative pressure ventilation device of claim 13, wherein the system of inflatable bladders comprises inlet and outlet ports to allow gas or liquid to enter and exit the inflatable bladders while maintaining a predetermined pressure in the bladders.

15. The negative pressure ventilation device of claim 1, wherein the sealing arrangement comprises apical and caudal annular seals between the tubular enclosure and the patient's torso.

16. The negative pressure ventilation device of claim 15, wherein the apical and caudal annular seals are tubular and inflatable.

17. A method for negative pressure ventilation using the negative pressure ventilation device of claim 1, comprising:
inflating the tubular enclosure surrounding a patient's torso for defining a space between the tubular enclosure and the patient's torso; and
producing through the port mounted to the inflatable tubular enclosure a negative pressure in the space between the enclosure and the patient's torso.

18. The method of claim 17, wherein inflating the tubular enclosure comprises inflating the system of inflatable bladders.

19. The method of claim 18, wherein inflating the tubular enclosure comprises inflating the inflatable bladders of the system simultaneously.

20. The method of claim 18, comprising circulating gas or liquid through the system of inflatable bladders through inlet and outlet ports while maintaining a predetermined pressure in the bladders.

21. The method of claim 20, comprising tempering the gas or liquid.

22. The method of claim 17, wherein the sealing arrangement comprises apical and caudal annular seals between the tubular enclosure and the patient's torso, wherein the apical and caudal annular seals are tubular and inflatable, and wherein the method comprises inflating the apical and caudal annular seals and adjusting a pressure in the apical and caudal annular seals in synchrony with patient's breathing cycles.

23. A negative pressure ventilation system, comprising:
the negative pressure ventilation device of claim 1;
a neural controller configured to receive a signal representative of an inspiratory effort of the patient and to produce a synchronization control signal in response to the received inspiratory effort representative signal; and
a pressure controller for producing a negative pressure in the space between the tubular enclosure and the patient's torso in response to the synchronization control signal from the neural controller.

24. The negative pressure ventilation system of claim 23, wherein the pressure controller is configured to lower the negative pressure when the inspiratory effort of the patient increases.

25. The negative pressure ventilation system of claim 23, comprising an electromyographic (EMG) sensor operatively connected to the neural controller and providing the signal representative of the inspiratory effort of the patient.

26. A negative pressure ventilation system, comprising:
the negative pressure ventilation device of claim 15;
a neural controller configured to receive a signal representative of an inspiratory effort of the patient and to produce a synchronization control signal in response to the received inspiratory effort representative signal; and
a pressure controller for producing:
a negative pressure in the space between the tubular enclosure and the patient's torso in response to the synchronization control signal from the neural controller; and
positive pressures in the apical and caudal annular seals, the positive pressures varying in synchrony with breathing cycles of the patient to minimize pressures applied on the skin of the patient by the apical and caudal annular seals.
